(19) United States
(12) Patent Application Publication
(10) Pub. No.: US 2024/0086223 A1
(43) Pub. Date: Mar. 14, 2024

(54) LOW-CODE DEVELOPMENT PLATFORM FOR EXTENDING WORKLOAD PROVISIONING

(71) Applicant: VMware, Inc., Palo Alto, CA (US)

(72) Inventors: Tony Georgiev, München (DE); Antonio Filipov, Sofia (BG); Martin Petkov, Sofia (BG); Elina Valinkova, Sofia (BG); Vera Mollova, Sofia (BG); Martin Vuchkov, Sofia (BG)

(73) Assignee: VMware, Inc., Palo Alto, CA (US)

(21) Appl. No.: 18/244,079

(22) Filed: Sep. 8, 2023

Related U.S. Application Data
(60) Provisional application No. 63/405,157, filed on Sep. 9, 2022.

(51) Int. Cl. G06F 9/455

(52) U.S. Cl. CPC G06F 9/45558; G06F 2009/45583

(57) ABSTRACT

The present disclosure relates to extending workload provisioning using a low-code development platform. Some embodiments include a medium having instructions to provide an interface for creating a custom resource in a virtualized environment, the interface including a first portion configured to receive summary information corresponding to the custom resource, and a second portion configured to receive a schema corresponding to the custom resource. Some embodiments include creating the custom resource according to the summary information and the schema.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for extending workload provisioning using a low-code development platform according to one or more embodiments of the present disclosure.

FIG. 2 is a screenshot of a UI illustrating a blueprint including multiple resource elements according to one or more embodiments of the present disclosure.

FIG. 3 is a screenshot of a UI illustrating a custom resource creation form according to one or more embodiments of the present disclosure.

FIG. 4 is a screenshot illustrating a custom resource schema according to one or more embodiments of the present disclosure.

FIG. 5 is a screenshot illustrating a custom resource schema UI according to one or more embodiments of the present disclosure.

FIG. 6 is a diagram of a system for extending workload provisioning using a low-code development platform according to one or more embodiments of the present disclosure.

FIG. 7 is a diagram of a machine for extending workload provisioning using a low-code development platform according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

The present disclosure includes an extensible mechanism to provide additional value to a workload provisioning platform (sometimes referred to herein as a “cloud automation platform” or simply “platform”), by allowing anyone with basic coding skills to create new resource types and enhance existing ones, to support specific requirements in their business domain. As known to those of skill in the art, existing resource types include CPU, memory, power, storage, and network resources. It is noted that throughout the present disclosure, reference is made to the implementation of such a solution in the context of VMware's vRA (vRealize Automation), an infrastructure automation platform. However, the same principles can be applied to a generic platform (e.g., Kubernetes). Users that can create these custom resource definitions are referred to herein as authors. Users that consume the provisioned custom resource are referred to herein as consumers.

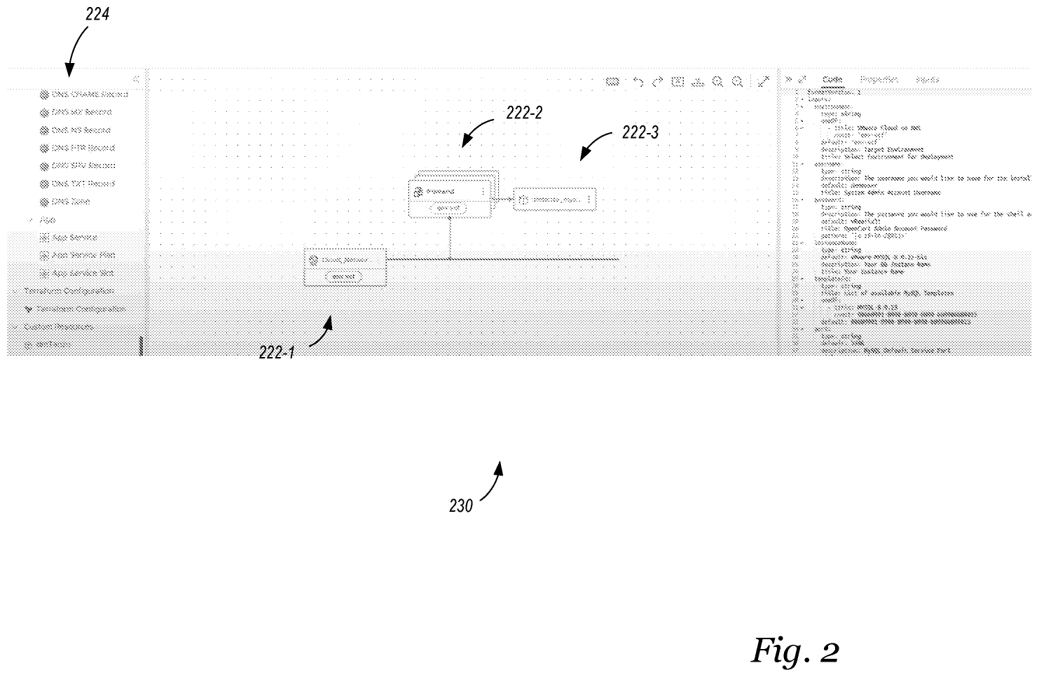

A powerful provisioning platform in accordance with the present disclosure provides many out of the box features, but also provides an extensible mechanism. As there are different customers of the platform there are different use cases, requirements, and domains to fulfil. For a platform like vRA, it means that out-of-the-box it provides the tools to automate the provisioning of cloud and datacenter-based resources (e.g., virtual machines, containers, networks, data stores) all combined in a package, also known as blueprint (discussed below in connection with FIG. 2), and configured as best as the blueprint author wanted. Very often additional resources are also needed in one such blueprint/workload. These things can be provisioning of a user (e.g., creating an account for the user), calling an internal service to request hardware for the user (e.g., a laptop computing device), and/or updating a record in a database, for instance.

Such platforms, including vRA, have provided extension points where customers can hook and provide additional functionality to the platform. However, very often these would require deep knowledge of the internals of the platform good coding skills to develop a plugin with the programming language that the platform requires hosting the plugin somewhere and taking care of its service availability.

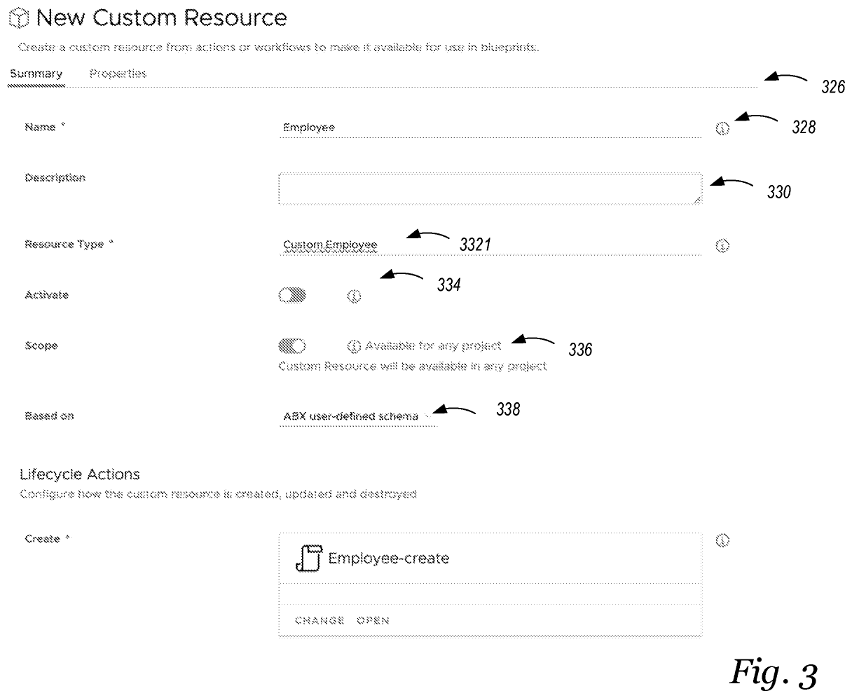

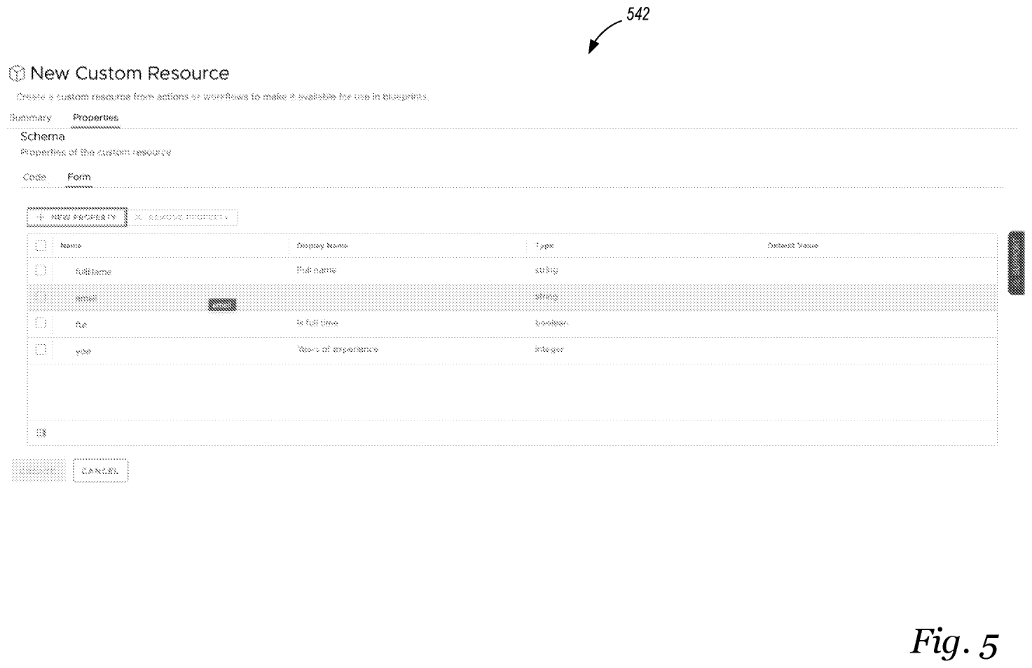

The present disclosure can solve the above challenges by providing an effortless way of defining the schema of custom resources. A schema is a representation of what properties a given resource may have. For example, if one is building a resource to represent an employee (discussed below in connection with FIG. 3), the resource may have properties like full name, email, whether the employee is full time, their years of experience, etc. This can easily be represented with a format widely used today in the industry: YAML (or even simpler, with a dedicated user interface for the purpose (discussed below in connection with FIG. 5).

Embodiments herein provide the ability to write the logic to create, list, and modify these resources in a generic way in a programming language of choice (e.g., JavaScript, Python, PowerShell, etc.). By providing such a way to write code, not tied to a specific system, authors are free to write it by themselves or rely on the numerous already publicly available code samples across the internet (e.g., Stack Overflow, GitHub, GitLab, etc.). Additionally, embodiments herein include storing the schema and executing the user-provided code in its own execution context, so that the author does not have to deal with such tasks.

With these simple points, anyone can create their custom resource. The scripts discussed above can tell the platform how to store the resources and how to retrieve their data. They implement a common template that can be autogenerated, and the author needs to only provide the custom domain logic, like connecting to a third party service or database. One result is that these new resources may be indistinguishable from built in resources. They can interact with other built in, or custom, resources and end users, both authors and consumers, and get a complete solution covering their daily goals. This leads to better user experience, complete domain coverage, without the need for additional professional services work, locally developed with minimum efforts and no prior knowledge of the internals of the bigger system.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

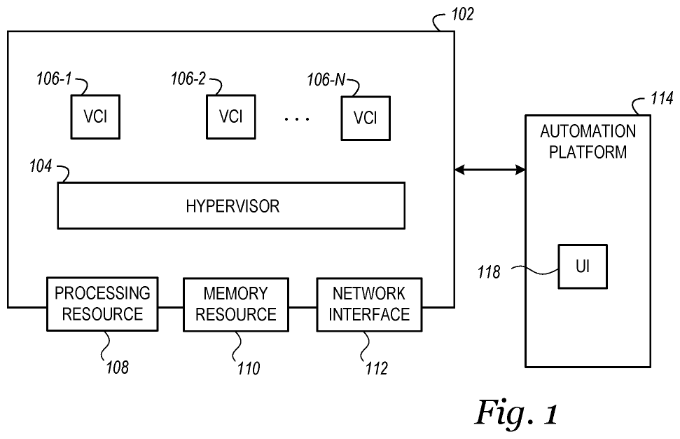

The figures herein follow a numbering convention in which the first digit or digits correspond to the drawing figure number and the remaining digits identify an element or component in the drawing. Analogous elements within a Figure may be referenced with a hyphen and extra numeral or letter. Such analogous elements may be generally referenced without the hyphen and extra numeral or letter. For example, elements 108-1, 108-2, and 108-N in FIG. 1 may be collectively referenced as 108. As used herein, the designator “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a diagram of a host and a system for extending workload provisioning using a low-code development platform according to one or more embodiments of the present disclosure. The host 102 can be provisioned with processing resource(s) 108 (e.g., one or more processors), memory resource(s) 110 (e.g., one or more main memory devices and/or storage memory devices), and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of VCIs 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs 106 can be local and/or remote to the host 102 (e.g., the VCIs 106 can be ultimately executed by hardware that may not be physically tied to the VCIs 106). For example, in a software defined data center, the VCIs 106 can be provisioned with resources that are generally available to the software defined data center and are not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. In some embodiments, the host 102 can be connected to (e.g., in communication with) an automation platform 114 (e.g., an infrastructure and/or cloud automation platform), which can be deployed on a VCI 106.

The automation platform 114 can provide a secure portal where authorized administrators, developers, or business users can request new IT services and/or manage cloud and IT resources while ensuring compliance with business policies. The automation platform 114 can be used to build and/or manage a multi-vendor cloud infrastructure, for instance. One example of such a automation platform is VMware's vRealize Automation (vRA), though embodiments herein are not so limited.

A UI 118 of the automation platform 114 can be used to build and/or manage a cloud infrastructure. vRA is a cloud management layer that sits on top of one or more clouds (e.g., different clouds). It can provision complex deployments and offer governance and management of these workloads and the resources in the cloud. The automation platform 114 can be designed to automate multiple clouds with secure, self-service provisioning.

FIG. 2 is a screenshot of a UI illustrating a blueprint 220 including multiple resource elements 222 according to one or more embodiments of the present disclosure. As referred to herein, a blueprint is a specification for cloud resources deployed by a user. Blueprint architects can assemble resources such as VCIs, storage, networks, etc. into blueprints that define the terms users request (e.g., from a catalog). Typically, blueprints describe fully-fledged applications that include multiple components. Deployed blueprints may also be referred to as cloud resources. Resource types 224 are shown in the screenshot of FIG. 2 as selectable elements that can be inserted into the blueprint 220.

FIG. 3 is a screenshot of a UI illustrating a custom resource creation form 326 according to one or more embodiments of the present disclosure. The form 326 illustrated in FIG. 3 can be used to create a new resource type, which can be displayed as a selectable element 226, previously described in connection with FIG. 2.

As shown in the example illustrated in FIG. 3, the UI can include a name field 328, a description field 330, a resource type field 332, an activate element 334, a scope element 336, and a based on menu 338. It is to be understood that the types, appearance, and/or layout of the display elements of the UI illustrated in FIG. 3 are not intended to be taken in a limiting sense. Embodiments of the present disclosure are not limited to the particular example illustrated in FIG. 3.

The name field 338 can be used to input a name of the resource type to be created. The description field 330 can be used to input a description of the resource type to be created. The resource type field 332, as shown, indicates that the resource is custom. The activate element 334 can be toggled to activate the resource element once created. The scope element 336 can be used to define the type(s) of projects in which the custom resource will be available. The based on menu 338, as shown, can indicate that the custom resource is based on an ABX user-defined schema (discussed further below).

Once the custom resource is created via the UI illustrated in FIG. 3, a blueprint can be created and/or modified to include the custom resource. The blueprint can be deployed. The newly-created custom resource is then visible (e.g., in a list as shown in FIG. 2).

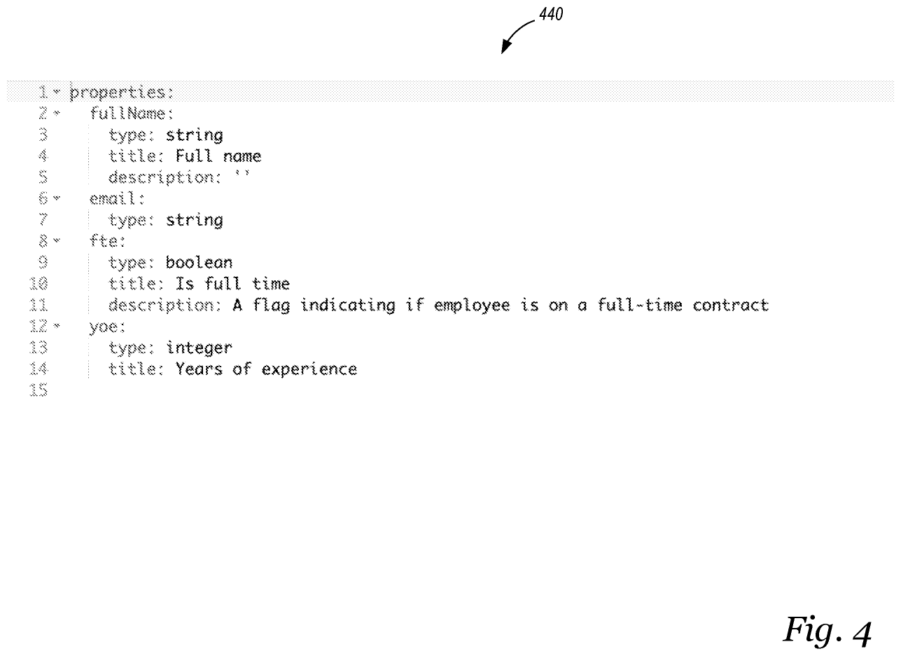

FIG. 4 is a screenshot illustrating a custom resource schema according to one or more embodiments of the present disclosure. A schema is a representation of what properties a given resource may have. For example, if one is building a resource to represent an employee, the resource may have properties like full name, email, whether the employee is full time, their years of experience, etc. This can be represented in a YAML format as shown in FIG. 4.

FIG. 5 is a screenshot illustrating a custom resource schema UI 542 according to one or more embodiments of the present disclosure. The UI 542 can be a dedicated UI for creating a custom resource schema in accordance with embodiments herein. A user can use the UI 542 to input properties of the custom resource that will be used to create the schema. Such properties can include, for instance, name, display name, type, and default value.

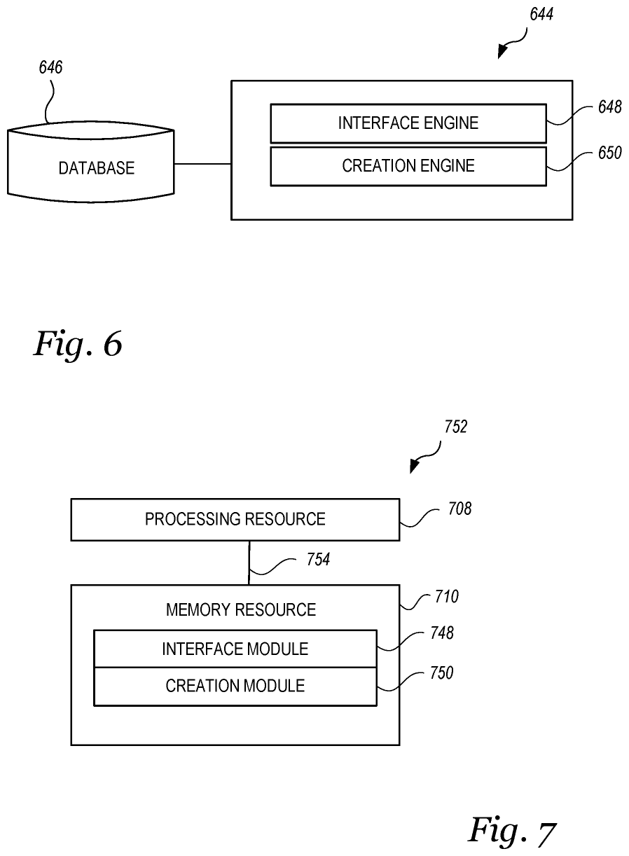

FIG. 6 is a diagram of a system 644 for extending workload provisioning using a low-code development platform according to one or more embodiments of the present disclosure. The system 644 can include a database 646 and/or a number of engines, for example interface engine 648 and/or creation engine 650, and can be in communication with the database 646 via a communication link. The system 644 can include additional or fewer engines than illustrated to perform the various functions described herein. The system can represent program instructions and/or hardware of a machine (e.g., machine 752 as referenced in FIG. 7, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the interface engine 648 can include a combination of hardware and program instructions that is configured to provide an interface for creating a custom resource in a virtualized environment. The interface includes, in some embodiments, a first portion configured to receive summary information corresponding to the custom resource. The interface includes, in some embodiments, a second portion configured to receive a schema corresponding to the custom resource. In some embodiments, the creation engine 650 can include a combination of hardware and program instructions that is configured to create the custom resource according to the summary information and the schema.

FIG. 7 is a diagram of a machine for extending workload provisioning using a low-code development platform according to one or more embodiments of the present disclosure. The machine 752 can utilize software, hardware, firmware, and/or logic to perform a number of functions. The machine 752 can be a combination of hardware and program instructions configured to perform a number of functions (e.g., actions). The hardware, for example, can include a number of processing resources 708 and a number of memory resources 710, such as a machine-readable medium (MRM) or other memory resources 710. The memory resources 710 can be internal and/or external to the machine 752 (e.g., the machine 752 can include internal memory resources and have access to external memory resources). In some embodiments, the machine 752 can be a virtual computing instance (VCI). The program instructions (e.g., machine-readable instructions (MRI)) can include instructions stored on the MRM to implement a particular function (e.g., an action such as configuring a certificate, as described herein). The set of MRI can be executable by one or more of the processing resources 708. The memory resources 710 can be coupled to the machine 752 in a wired and/or wireless manner. For example, the memory resources 710 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 710 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 708 can be coupled to the memory resources 710 via a communication path 754. The communication path 754 can be local or remote to the machine 752. Examples of a local communication path 754 can include an electronic bus internal to a machine, where the memory resources 710 are in communication with the processing resources 708 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 754 can be such that the memory resources 710 are remote from the processing resources 708, such as in a network connection between the memory resources 710 and the processing resources 708. That is, the communication path 754 can be a network connection. Examples of such a network connection can include a local area network (LAN), wide area network (WAN), personal area network (PAN), and the Internet, among others.

As shown in FIG. 7, the MRI stored in the memory resources 710 can be segmented into a number of modules 748,750 that when executed by the processing resources 708 can perform a number of functions. As used herein a module includes a set of instructions included to perform a particular task or action. The number of modules 748, 750 can be sub-modules of other modules. For example, the creation module 750 can be a sub-module of the interface module 748 and/or can be contained within a single module. Furthermore, the number of modules 748, 750 can comprise individual modules separate and distinct from one another. Examples are not limited to the specific modules 748, 750 illustrated in FIG. 7.

Each of the number of modules 748, 750 can include program instructions and/or a combination of hardware and program instructions that, when executed by a processing resource 708, can function as a corresponding engine as described with respect to FIG. 6. For example, the interface module 748 can include program instructions and/or a combination of hardware and program instructions that, when executed by a processing resource 708, can function as the interface engine 648, though embodiments of the present disclosure are not so limited.

The machine 752 can include an interface module 748, which can include instructions to provide an interface for creating a custom resource in a virtualized environment. Such an interface can include, for instance, a first portion configured to receive summary information corresponding to the custom resource, and a second portion configured to receive a schema corresponding to the custom resource. The machine 752 can include a creation module 750, which can include instructions to create the custom resource according to the summary information and the schema.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A non-transitory machine-readable medium having instructions stored thereon which, when executed by a processor, cause the processor to:
provide an interface for creating a custom resource in a virtualized environment, wherein the interface includes:
a first portion configured to receive summary information corresponding to the custom resource; and
a second portion configured to receive a schema corresponding to the custom resource; and
create the custom resource according to the summary information and the schema.

2. The medium of claim 1, wherein the summary information includes:
a name of the custom resource;
a description of the custom resource; and
a type of the custom resource.

3. The medium of claim 1, wherein the second portion is configured to receive code as the schema corresponding to the custom resource.

4. The medium of claim 3, wherein the code is in a YAML format.

5. The medium of claim 1, wherein the second portion includes a form configured to receive properties of the custom resource.

6. The medium of claim 5, including instructions to create the schema based on the received properties of the custom resource.

7. The medium of claim 1, wherein the custom resource represents an account associated with an employee of a business.

8. A method, comprising:
providing an interface for creating a custom resource in a virtualized environment,
receiving, via a first portion of the interface, summary information corresponding to the custom resource; and
receiving, via a second portion of the interface, a schema corresponding to the custom resource; and
creating the custom resource according to the summary information and the schema.

9. The method of claim 8, wherein the summary information includes:
a name of the custom resource;
a description of the custom resource; and
a type of the custom resource.

10. The method of claim 8, wherein the method includes receiving code, via the second portion, as the schema corresponding to the custom resource.

11. The method of claim 10, wherein the code is in a YAML format.

12. The method of claim 8, wherein the method includes providing a form, via the second portion, configured to receive properties of the custom resource.

13. The method of claim 12, wherein the method includes creating the schema based on the received properties of the custom resource.

14. The method of claim 8, wherein the custom resource represents an account associated with an employee of a business.

15. A system, comprising:
an interface engine configured to provide an interface for creating a custom resource in a virtualized environment, wherein the interface includes:
a first portion configured to receive summary information corresponding to the custom resource; and
a second portion configured to receive a schema corresponding to the custom resource; and
a creation engine configured to create the custom resource according to the summary information and the schema.

16. The system of claim 15, wherein the summary information includes:
a name of the custom resource;
a description of the custom resource; and
a type of the custom resource.

17. The system of claim 15, wherein the second portion is configured to receive code as the schema corresponding to the custom resource.

18. The system of claim 17, wherein the code is in a YAML format.

19. The system of claim 15, wherein the second portion includes a form configured to receive properties of the custom resource.

20. The system of claim 19, wherein the creation engine is configured to create the schema based on the received properties of the custom resource.
